(19) United States
(12) Patent Application Publication
(10) Pub. No.: US 2026/0084675 A1
(43) Pub. Date: Mar. 26, 2026

(54) THERMAL MANAGEMENT OF PARKING BRAKE ASSEMBLY UNDER BELOW FREEZING TEMPERATURES

(71) Applicant: HL MANDO CORPORATION, Gyeonggi-do (KR)

(72) Inventors: Gyunghun SIM, Auburn, MI (US); Manoj Kumar Reddy MOTAKATLA, Auburn, MI (US)

(21) Appl. No.: 19/310,321

(22) Filed: Aug. 26, 2025

Related U.S. Application Data
(60) Provisional application No. 63/697,430, filed on Sep. 20, 2024.

(51) Int. Cl. B60T 17/00; B60T 13/74; B60T 17/22

(52) U.S. Cl. CPC B60T 17/006; B60T 13/74; B60T 17/22

(57) ABSTRACT

An electromechanical brake (EMB) system is provided. The EMB system includes: an actuator assembly including an electric motor configured to generate torque for moving a brake pad assembly to apply or release a brake and a driven pulley configured to transmit the torque generated from the electric motor; a parking brake assembly including a parking pawl configured to engage against the driven pulley in a parking brake applied state of a vehicle and a pawl actuator configured to move the parking pawl to engage against the driven pulley; and an electronic control unit (ECU) configured to heat up the parking brake assembly in response to obtaining a parking brake apply request under one or more below freezing ambient temperature conditions.

### CROSS REFERENCE TO PARENT APPLICATIONS

This application claims the benefit of U.S. patent application Ser. No. 63/697,430 filed on Sep. 20, 2024, entitled “HOW EMB PARKING BRAKE WORKS AT LOW TEMPERATURE”, the entirety of which is incorporated herein by reference.

### BACKGROUND

Various embodiments of the present disclosure generally relate to an electromechanical brake (EMB) system (also referred to herein as an “EMB assembly”) and more particularly to an inductive position sensor of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) assembly may comprise: an actuator assembly comprising an electric motor configured to generate torque for moving a brake pad assembly to apply or release a brake and a driven pulley configured to transmit the torque generated from the electric motor; a parking brake assembly comprising a parking pawl configured to engage against the driven pulley in a parking brake applied state of a vehicle and a pawl actuator configured to move the parking pawl to engage against the driven pulley; and an electronic control unit (ECU) configured to heat up the parking brake assembly in response to obtaining a parking brake apply request under one or more below freezing ambient temperature conditions.

The ECU is further configured to: determine, in response to obtaining the parking brake release request, whether the parking brake assembly is potentially frozen; and in response to determining that the parking brake assembly is potentially frozen, provide a current to pawl actuator to heat up the pawl actuator and the parking pawl.

The ECU is configured to determine whether the parking brake assembly is potentially frozen by using an actual temperature of the EMB assembly or an estimated temperature of the EMB assembly.

The ECU obtains temperature readings from at least one temperature sensor installed within the brake assembly.

The estimated temperature of the EMB assembly is based on an ambient temperature of the vehicle provided to the ECU from a controller of the vehicle that is separate from the ECU.

The ECU is configured to determine whether the parking brake assembly is potentially frozen using an input from a driver of the vehicle indicating that the driver believes the parking brake assembly could be frozen.

At least one portion of the pawl actuator is in direct contact with the parking pawl.

The pawl actuator comprises an armature and pin assembly and a solenoid spring, and the ECU is configured to provide the current to the solenoid spring to generate heat within the solenoid spring, the heat generated within the solenoid spring causing unfreezing of the parking pawl.

The ECU is further configured to: cause, after providing the current to the pawl actuator, the driven pulley to rotate at least one tooth distance.

The ECU is further configured to: cause, simultaneously with causing the driven pulley to rotate the at least one tooth distance, the pawl actuator to disengage with the parking paw.

According to some embodiments of the present disclosure, a method may comprise: determining whether a vehicle is under one or more below freezing ambient temperature conditions; and heating up a parking brake assembly of the EMB assembly in response to determining that the vehicle is under the one or more below freezing ambient temperature conditions and in response to obtaining of a parking brake apply request, wherein the EMB assembly comprises an actuator assembly comprising an electric motor configured to generate torque for moving a brake pad assembly to apply or release a brake and a driven pulley configured to transmit the torque generated from the electric motor; and a parking brake assembly comprising a parking pawl configured to engage against the driven pulley in a parking brake applied state of a vehicle and a pawl actuator configured to move the parking pawl to engage against the driven pulley.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2 shows a cross-sectional view of a parking brake of the brake assembly of FIG. 1 according to one or more exemplary embodiments of the present disclosure.

FIG. 3 shows a flowchart according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

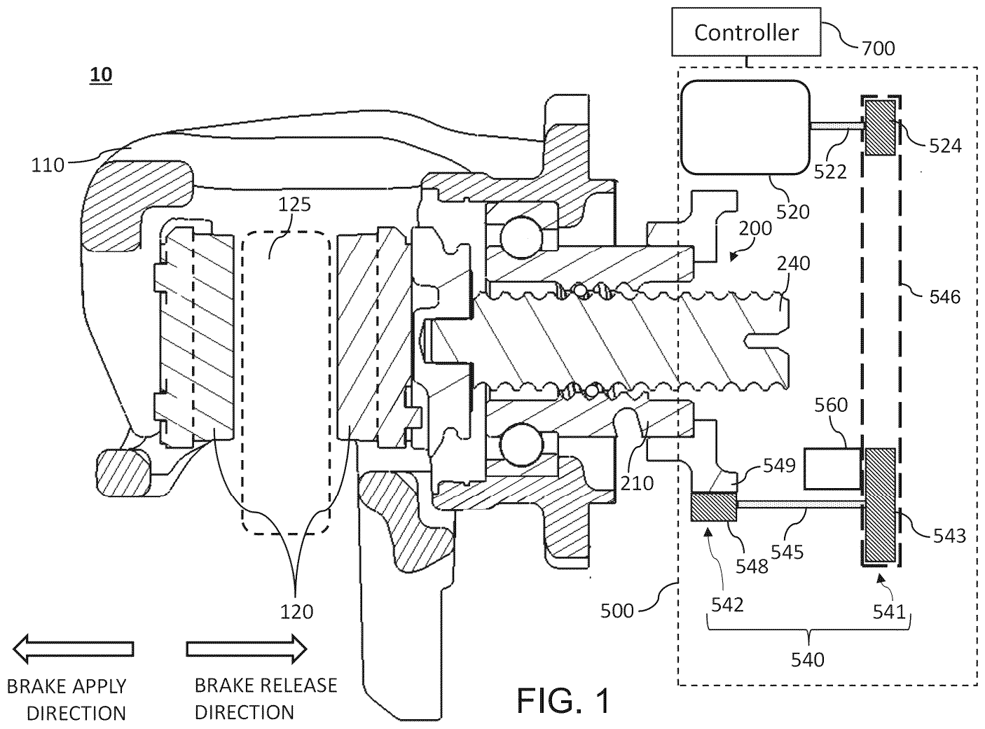

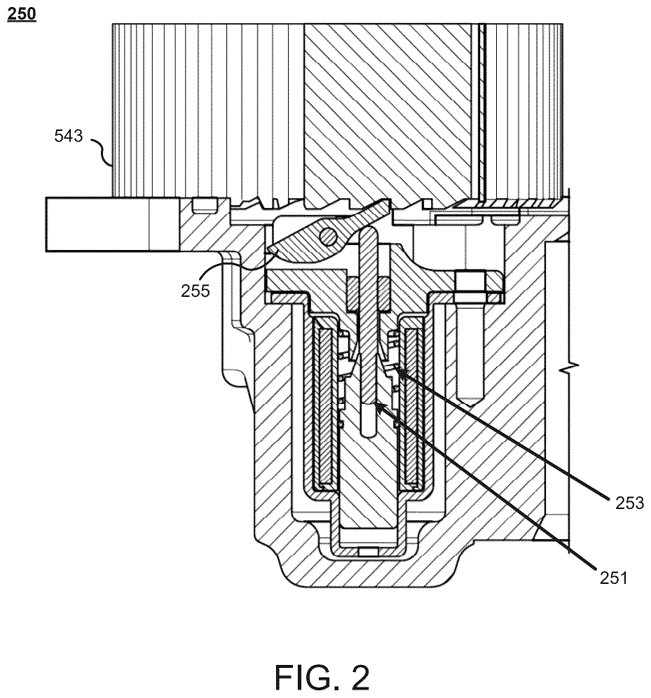

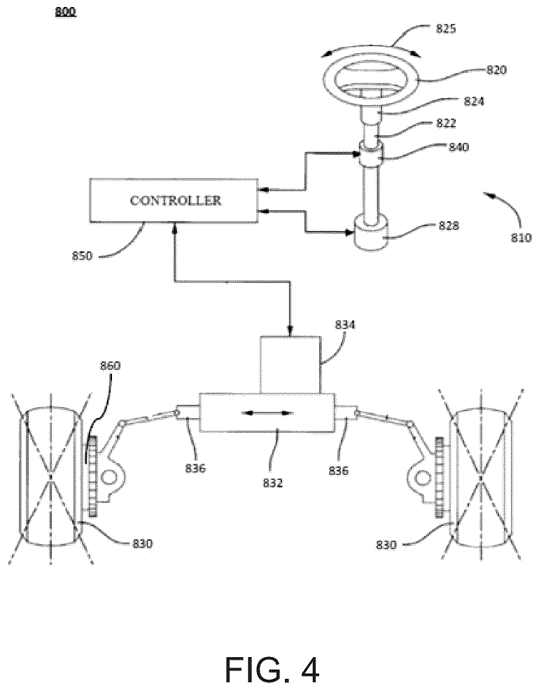

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Such brake systems may be equipped with a parking brake to prevent movement of wheels when the vehicle is not in operation, for instance, when the vehicle is stopped or parked. The parking brake may refer to a mechanism for restraining or holding a parked vehicle in place. The parked status of the vehicle can be maintained by a parking lock mechanism, for example, but not limited to, a strut, a parking pawl, engagement of one or more gears, and so on. More specifically, according to some embodiments of the present disclosure, when a parking brake (e.g., of an electromechanical brake (EMB) assembly is applied, a latch-like structure (e.g., a latch, a parking pawl, or the like) engages with a gear (e.g., driven pulley 543 of FIGS. 1 and 2, or the like) to prevent the gear from moving while the parking brake is applied. A reliable parking brake that can be operated safely and reliably at any temperature (e.g., at high temperatures, at freezing temperatures, or the like) is particularly important and sought after.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125).

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

FIG. 2 shows a parking brake 260 (also referred to herein as a “parking brake assembly”) of the brake assembly 10 of FIG. 1 in accordance with one or more exemplary embodiments of the present disclosure.

As shown in FIG. 2, the parking brake 260 may include an actuating mechanism (also referred to herein as a “pawl actuator”) made up of, for example, an armature and pin assembly 251 and a solenoid spring 253. The actuating mechanism may be configured to actuate parking pawl 255 such that parking pawl 255 engages with driven pulley 543 (namely, with one or more teeth of the driven pulley 543) to prevent movement of the driven pulley 543 when a parking brake operation is performed.

Although the actuating mechanism is shown in FIG. 2 as being made up of an armature and pin assembly 251 and a solenoid spring 253, other mechanical systems and/or assemblies that are capable of physically actuating the parking pawl 255 may also be used (instead of the armature and pin assembly 251 and solenoid spring 253 combination of FIG. 2) without departing from the scope of embodiments disclosed herein.

In embodiments, operation of the actuating mechanism may also be controlled by controller 700 of the brake assembly 10. For example, during a parking brake application operation, the controller 700 may cause (e.g., via providing one or more analog and/or digital signals to armature and pin assembly 251) the armature and pin assembly 251 to push the parking pawl 255 against the driven pulley 243 such that the parking pawl 255 is locked into one of the teeth of the driven pulley 543 (which generates a high clamp force that prevents movement of the driven pulley 543).

Controller 700 may also cause (e.g., via providing of the one or more analog and/or digital signals to armature and pin assembly 251) to apply a current on the solenoid spring 253. Such application of the current on the solenoid spring 253 may advantageously cause the solenoid spring 253 to heat up and melt (e.g., unfreeze) and frozen parts of the parking brake 260 such as the armature and pin assembly 251, the solenoid spring 253 itself, and/or the parking pawl 255 when the vehicle has remained in a parking brake applied state in below freezing (e.g., under 0 degree Celsius or 32 degrees Fahrenheit temperatures for an extended time).

Namely, when a vehicle remains parked in such below freezing temperature for an extended period of time, any of the armature and pin assembly 251, the solenoid spring 253, and/or the parking pawl 255 may become frozen. As a result, when a parking brake release (e.g., cancellation) operation is performed, the parking pawl 255 may not be able to dislodge itself from the driven pulley 543 and may remain stuck within the tooth of the driven pulley 543 in which it has engaged.

In embodiments, the amount of current provided by the armature and pin assembly 251 to the solenoid spring may depend on at least one (or a combination thereof) of: (i) a temperature of the brake assembly 10 as detected by the controller 700 (e.g., via at least one temperature sensor installed within the brake assembly 10 or the like); (ii) an estimated temperature of brake assembly 10 based on an ambient temperature of the vehicle received by the controller 700 from a separate and independently operating central controller (e.g., a chassis controller, or the like) of the vehicle; (iii) a current rating of the solenoid spring 253; (iv) an amount of current producible by the controller and/or the armature and pin assembly 251; (v) a current rating of the armature and pin assembly; (vi) a predetermined current value that is pre-set by a manufacturer of the brake assembly 10 and/or of the vehicle; or the like.

In embodiments, the amount of time that the current is applied to the solenoid spring 253 may also depend on: (i) a temperature of the brake assembly 10 as detected by the controller 700 (e.g., via at least one temperature sensor installed within the brake assembly 10 or the like); (ii) an estimated temperature of brake assembly 10 based on an ambient temperature of the vehicle received by the controller 700 from a separate and independently operating central controller (e.g., a chassis controller, or the like) of the vehicle; (iii) a current rating of the solenoid spring 253; (iv) an amount of current producible by the controller and/or the armature and pin assembly 251; (v) a current rating of the armature and pin assembly; (vi) a predetermined time value that is pre-set by a manufacturer of the brake assembly 10 and/or of the vehicle; or the like.

For example, the controller 700 may be configured to store (e.g., within a memory of the controller 700) a set of rules (e.g., in the form of a list, a look up table, or the like) defining how much current can be applied for how long depending on an actual and/or estimated temperature of the brake assembly 10.

Once the solenoid spring 253 has been heated up via application of the current through the solenoid spring 253, the potentially frozen parts may now be thawed, which now allows for the parking pawl 255 to be disengaged from the driven pulley 543.

To assist the parking pawl 255 from disengaging from the driven pulley 543 after performance of the thawing operation, the controller 700 may cause the electric motor 50 to rotate the driven pulley 543 at least one tooth distance. Such rotation of the driven pulley 543 at least one tooth distance may push the parking pawl 255 out of the tooth in which the parking pawl 255 was engaged (assuming that the parking pawl 255 is successfully thawed to a point where the parking pawl 255 is able to move (e.g., actuate) again).

As a result, the parking brake 250 of the brake assembly 10 can advantageously provide safe and reliable operation (e.g., parking brake apply and parking brake release operations) at any temperature (e.g., high heat temperatures, below freezing temperatures, or the like).

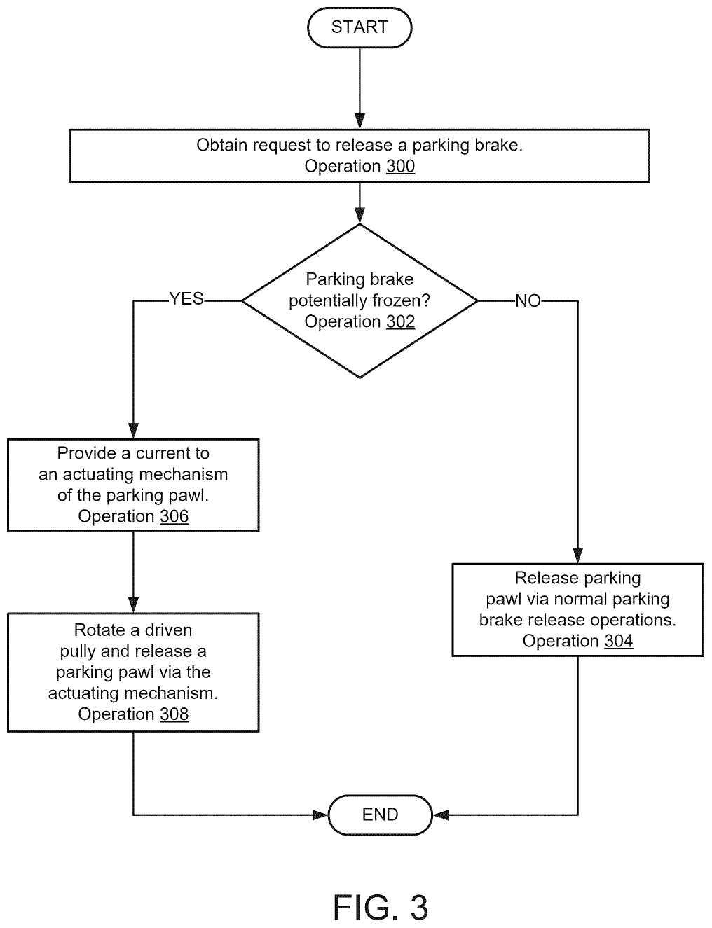

Turning to FIG. 3, a flowchart illustrating a method for managing a parking brake of a brake assembly according to one or more exemplary embodiments of the present disclosure. The operations of the flowchart of FIG. 3 may be performed, for example, by the controller 700 of the brake assembly 10 and/or by the central controller of the vehicle. Although shown as a series of temporal steps, the operations of the flowchart 3 need not be performed in the exact order shown in FIG. 3 and any of the operations can be performed in any order without departing from the scope and spirit of embodiments disclosed herein.

In Operation 300, and as discussed above in reference to FIG. 2, a parking brake release request may be obtained (e.g., from a driver of the vehicle). In embodiments, the parking brake release request may be obtained after the vehicle has been parking in below freezing temperatures for an extended period of time.

In Operation 302, and as discussed above in reference to FIG. 2, a determination may be made as to whether the parking brake is potentially frozen 302.

In embodiments, the determination may be made by obtaining an actual temperature (e.g., via one or more temperature sensors installed in brake assembly 10) of the brake assembly 10, which would also reflect the temperature of the parking brake 260 installed therein. In embodiments, the determination may be made through estimating a temperature of the brake assembly 10 (e.g., using temperatures of the vehicle and/or an ambient environment of the vehicle provided to the controller 700 via the central controller of the vehicle or the like).

Yet in other embodiments, the determination may be made based on an input supplied by the user (e.g., an input from the user indicating that the user thinks that the parking brake (or one or more components thereof) has potentially frozen over. For example, if the central controller of the vehicle has determined that the vehicle has been parked in below freezing conditions for a extended period of time (e.g., as defined and/or pre-set by a manufacturer of the brake assembly 10 and/or the vehicle), the central controller may notify the driver (e.g., via the infotainment system of the like of the vehicle) that the parking brake (or one or more components thereof) may have potentially frozen over. This then allows the driver to cause the controller 700 and/or the central controller to activate mechanisms for thawing (e.g., unfreezing the parking brake).

In embodiments, the required below freezing temperature and/or the required time (e.g., duration) for the vehicle to reaming parked at a certain below freezing temperature for determination that the parking brake (or one or more components thereof) has potentially frozen over may be pre-defined (e.g., pre-set) by a manufacturer of the brake assembly 10 and/or the vehicle.

In the event that the determination at Operation 302 is NO (i.e., the parking brake is determined as not potentially being frozen), the process proceeds to Operation 304 where the parking pawl is released from the driven pulley 543 to release the vehicle from the parking brake engaged state via normal parking brake release operations (e.g., via the controller 700 causing disengagement of the armature and pin assembly 251 against the parking pawl 255 such that the parking pawl 255 is able to naturally disengage from the driven pulley 543 without requiring the heating up of any components of the parking brake).

The method of FIG. 3 may end following Operation 304.

Alternatively, in the event that the determination at Operation 302 is YES (i.e., the parking brake is determined as potentially being frozen), the process may proceed to Operation 306 where a current may be provided to an actuating mechanism of the parking pawl 255. For example, as discussed above in reference to FIG. 2, a current may be provided to solenoid spring 253 through armature and pin assembly 251 to heat up the solenoid spring 253 in order to thaw out (e.g., unfreeze) any of the potentially frozen components of the parking brake such as the pin of the armature and pin assembly 251, the solenoid spring 253 itself, and/or the parking pawl 255.

In embodiments, and as discussed above in reference to FIG. 2, the amount of current provided and the amount of time that the current is provided (e.g., to the solenoid spring 253) to generate heat within the parking brake may be pre-defined and/or pre-set by a manufacturer of the brake assembly 10 and/or the vehicle based on various factors (e.g., current rating of the components, the actual and/or estimated temperature of the parking brake, a predefined set of rules stored in memory of the controller 700, or the like).

At Operation 208, and as discussed above in reference to FIG. 2, after the current is applied to the actuating mechanism of the parking pawl 255 (e.g., for a predetermined period of time or the like), the driven pully 543 may be rotated (e.g., via control of electric motor 50 by controller 700 of brake assembly) to release (e.g., push out) the parking pawl 255 from the driven pulley 543. Simultaneously, the actuating mechanism (e.g., the armature and pin assembly 251) may be caused to disengage with the parking pawl 255 (e.g., to stop pushing the parking pawl 255 against the driven pulley 543).

In embodiments, the driven pulley 543 may be rotated at least one tooth distance. This advantageously aids in the releasing of the parking pawl 255 from the tooth of the driven pulley 543 in which the parking pawl 255 is currently engaged.

The method of FIG. 3 may end following Operation 308.

Any of the operations (e.g., Operations 300 through 308) discussed in reference to FIG. 3 may be performed, in part or whole, by digital processors (e.g., central processors, processor cores, etc.) that execute corresponding instructions (e.g., computer code/software) of controller 700. Execution of the instructions may cause the digital processors to initiate performance of the processes. Any portions of the operations (e.g., Operations 300 through 304) may be performed by the digital processors and/or other devices. For example, executing the instructions may cause the digital processors to perform actions that directly contribute to performance of the operations, and/or indirectly contribute to performance of the operations by causing (e.g., initiating) other hardware components to perform actions that directly contribute to the performance of the operations.

Additionally, any of the operations discussed in reference to FIG. 3 may be performed, in part or whole, by special purpose hardware components of the controller 700 such as digital signal processors, application specific integrated circuits, programmable gate arrays, graphics processing units, data processing units, and/or other types of hardware components. These special purpose hardware components may include circuitry and/or semiconductor devices adapted to perform the operations. For example, any of the special purpose hardware components may be implemented using complementary metal-oxide semiconductor-based devices (e.g., computer chips).

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 820 from the road wheels 830. Accordingly, the steer-by wire steering system may comprise a feedback actuator or steering feel actuator 828 comprising an electric motor which is connected to the steering shaft or steering shaft 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) assembly comprising:
an actuator assembly comprising an electric motor configured to generate torque for moving a brake pad assembly to apply or release a brake and a driven pulley configured to transmit the torque generated from the electric motor;
a parking brake assembly comprising a parking pawl configured to engage against the driven pulley in a parking brake applied state of a vehicle and a pawl actuator configured to move the parking pawl to engage against the driven pulley; and
an electronic control unit (ECU) configured to heat up the parking brake assembly in response to obtaining a parking brake apply request under one or more below freezing ambient temperature conditions.

2. The EMB assembly of claim 1, wherein the ECU is further configured to:
determine, in response to obtaining the parking brake release request, whether the parking brake assembly is potentially frozen; and
in response to determining that the parking brake assembly is potentially frozen, provide a current to pawl actuator to heat up the pawl actuator and the parking pawl.

3. The EMB assembly of claim 2, wherein the ECU is configured to determine whether the parking brake assembly is potentially frozen by using an actual temperature of the EMB assembly or an estimated temperature of the EMB assembly.

4. The EMB assembly of claim 3, wherein the ECU obtains temperature readings from at least one temperature sensor installed within the brake assembly.

5. The EMB assembly of claim 3, wherein the estimated temperature of the EMB assembly is based on an ambient temperature of the vehicle provided to the ECU from a controller of the vehicle that is separate from the ECU.

6. The EMB assembly of claim 2, wherein the ECU is configured to determine whether the parking brake assembly is potentially frozen using an input from a driver of the vehicle indicating that the driver believes the parking brake assembly could be frozen.

7. The EMB assembly of claim 2, wherein at least one portion of the pawl actuator is in direct contact with the parking pawl.

8. The EMB assembly of claim 7, wherein:
the pawl actuator comprises an armature and pin assembly and a solenoid spring, and
the ECU is configured to provide the current to the solenoid spring to generate heat within the solenoid spring, the heat generated within the solenoid spring causing unfreezing of the parking pawl.

9. The EMB assembly of claim 2, wherein the ECU is further configured to:
cause, after providing the current to the pawl actuator, the driven pulley to rotate at least one tooth distance.

10. The EMB assembly of claim 9, wherein the ECU is further configured to:
cause, simultaneously with causing the driven pulley to rotate the at least one tooth distance, the pawl actuator to disengage with the parking pawl.

11. A method for controlling an electromechanical brake (EMB) assembly, the method comprising:
determining whether a vehicle is under one or more below freezing ambient temperature conditions; and
heating up a parking brake assembly of the EMB assembly in response to determining that the vehicle is under the one or more below freezing ambient temperature conditions and in response to obtaining of a parking brake apply request, wherein the EMB assembly comprises an actuator assembly comprising an electric motor configured to generate torque for moving a brake pad assembly to apply or release a brake and a driven pulley configured to transmit the torque generated from the electric motor; and a parking brake assembly comprising a parking pawl configured to engage against the driven pulley in a parking brake applied state of a vehicle and a pawl actuator configured to move the parking pawl to engage against the driven pulley.

12. The method of claim 11, wherein the heating up of the parking brake assembly comprises:
determining, in response to the obtaining of the parking brake release request, whether the parking brake assembly is potentially frozen; and
in response to determining that the parking brake assembly is potentially frozen, providing a current to the pawl actuator to heat up the pawl actuator and the parking pawl.

13. The method of claim 12, wherein whether the parking brake assembly is potentially frozen is determined using an actual temperature of the EMB assembly or an estimated temperature of the EMB assembly.

14. The method of claim 13, wherein the actual temperature of the EMB assembly is based on temperature readings from at least one temperature sensor installed within the brake assembly.

15. The method of claim 13, wherein the estimated temperature of the EMB assembly is based on an ambient temperature of the vehicle sensed by one or more controllers of the vehicle.

16. The method claim 12, wherein whether the parking brake assembly is potentially frozen is determined using an input from a driver of the vehicle indicating that the driver believes the parking brake assembly could be frozen.

17. The method of claim 12, wherein at least one portion of the pawl actuator is in direct contact with the parking pawl.

18. The method of claim 17, wherein the pawl actuator comprises an armature and pin assembly and a solenoid spring, and the current is provided to the solenoid spring to generate heat within the solenoid spring, the heat generated within the solenoid spring causing unfreezing of the parking pawl.

19. The method of claim 12, wherein the heating up of the parking brake assembly further comprises:
causing, after providing the current to the pawl actuator, the driven pulley to rotate at least one tooth distance.

20. The method of claim 19, wherein the heating up of the parking brake assembly further comprises:
causing, simultaneously with causing the driven pulley to rotate the at least one tooth distance, the pawl actuator to disengage with the parking pawl.
